(19) United States
(12) Patent Application Publication
(10) Pub. No.: US 2007/0162812 A1
(43) Pub. Date: Jul. 12, 2007

(54) Decoding and reconstruction of data

(75) Inventor: Christoph Herrmann, Aachen (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N. V., Eindhoven (NL)

(21) Appl. No.: 10/577,088

(22) PCT Filed: Oct. 11, 2004
(86) PCT No.: PCT/IB04/52045

§ 371 Date: Dec. 21, 2006

(30) Foreign Application Priority Data
Oct. 23, 2003 (EP) 03103933.2

(51) Int. Cl. H04L 1/18

(52) U.S. Cl. 714/749

(57) ABSTRACT

When applying chase combining in the retransmission protocol of a telecommunication system or other schemes of retransmission protocols which use selfdecodable incremental redundancy, it may not in all cases be the best solution to combine the initial transmission of data up to the latest received. retransmission of the data and then to perform an error determination of the combined decoding result. Advantageously, according to an exemplary embodiment of the present invention, a combination of selected ones of the initial transmission and the following received retransmissions is performed, resulting in a combined decoding result of the data, which may then be checked for errors.

The present invention relates to decoding and reconstruction of data. More particularly, the present invention relates to a method for decoding and reconstructing of data, a communication system and a receiving station.

Several error control and recovery techniques in telecommunication systems are known. One of these techniques is the so-called automatic repeat request (hereinafter referred to as “ARQ”, protocol for controlling retransmissions in case of detected errors). The hybrid ARQ (hereinafter referred to as “HARQ”) combines ARQ with an error correcting code and has been shown to provide advantages in communication system throughput and makes the system more robust to bit errors caused by the imperfect channel. HARQ Type II and III uses combining techniques on the original initial and retransmitted data packets to improve the retransmission operation. The combining techniques may be soft-combining such as chase combining or incremental redundancy.

In the process of decoding the initial transmission of a data packet, soft-bits, i.e. quantized amplitudes, of each received bit are generated. In order to finally decide whether the received bit was a “1” or “0”, these amplitudes are compared with a threshold and e.g. all amplitudes above the threshold represent a bit value “1”, while all amplitudes less than or equal to the threshold represent the bit value “0”. This process is called threshold decision.

For transmission, a data packet is usually composed of the data payload and some cyclic redundancy check bits (hereinafter referred to as “CRC bits”), which are computed from the payload bits based on the CRC polynomial of degree r. Calculation of the CRC bits it usually done as follows: The payload bits are interpreted as the coefficients of a polynomial p(x) over the Galois field GF(2) (i.e. the field consisting of 0 and 1 only). The CRC bits are then the coefficients of the remainder polynomial, which is obtained, if x^{r}.p(x) is divided (observing that the coefficients are elements of GF(2)) by the CRC polynomial, as described in e.g. Andrew S. Tanenbaum, Computer Networks, Prentice Hall, 1988. Both payload and CRC bits (assuming that they sum up to n bits) are then fed into a channel encoder (which can be e.g. a convolutional encoder, a Turbo encoder, or an encoder for block codes), which produces n+m channel-encoded bits out of the n input bits. In the simplest case, the sequence of channel-encoded bits is then transmitted bit by bit over the communication channel, where one bit is represented by the amplitude of the pulse used for transmission of a bit.

On the receiving side, the amplitudes of each pulse in the sequence is sampled, and quantized, and stored in the so-called soft buffer. The quantized amplitude is an estimate for the received channel-encoded bit. The sequence of m+n quantized amplitudes is either directly fed to the channel decoder (so-called soft-decision), or first transformed into a sequence of “0” and “1” by means of a threshold decision, and then fed to the channel decoder (so-called hard-decision), which reconstructs a sequence of payload bits and CRC bits of the considered packet. Since the channel encoding is done by means of error-correcting codes, errors imposed by the imperfect channel can fully or only partly be corrected in the process of channel-decoding.

The decoding or data reconstruction process is considered successful, if based on the channel-decoded payload bits, the CRC bits (computed with the known CRC polynomial) from these channel-decoded payload bits equal the CRC bits, which were reconstructed in the channel-decoding process. An equivalent way of finding out, whether the decoding process is successful, is to interpret the channel-decoded payload bits together with the channel-decoded CRC bits as a polynomial with coefficients in the Galois field GF(2), which coefficients are these bits, and divide it by the known CRC polynomial. If and only if the remainder of this division is zero, the decoding process is considered successful.

In more advanced systems, groups of k consecutive bits are mapped to 2^{k} pairs of amplitudes (so-called signal points), where the amplitude of the first component in the pair determines e.g. the amplitude of the I-phase pulse and the second component in the pair determines the amplitude of the Q-phase pulse. The receiving side then samples amplitude values on I- and Q-phase, quantizes them, and finally takes a threshold decision to determine the (most likely) group of k bits sent. The case k=2 is known as QPSK (Quadrature Phase Shift Keying), k=4 represents 16-QAM (Quadrature Amplitude Modulation).

The above chase combining type HARQ is characterized in that the transmitting side retransmits the same data packet which was sent previously. Chase combining type HARQ of an initial transmission and the next retransmission is then done as follows:

The soft bits generated in the quantisation step and used in the unsuccessful reconstruction process of the initial transmission are kept in the soft buffer, until the retransmitted data packet is received and its bits have been sampled and quantized. The soft bits generated in the course of sampling and quantizing the bits of the retransmitted data packet are added soft bit-wise to the soft bits of the initial transmission. This new vector of soft bits replaces the soft bits currently contained in the soft buffer, i.e. those soft bits which were stored in the course of the reconstruction process of the initial transmission. The new vector of soft bits is either directly or after a transformation into a vector of “0” and “1” by means of a threshold decision fed into the channel decoder, which generates estimates-of the payload and CRC bits, then the CRC bits are computed from the estimates of the payload bits using the known CRC polynomial, and the computed CRC bits are compared with the estimates of the CRC bits. If both groups of CRC bits match, the data packet is considered as being reconstructed error free and the buffer for the soft bits may be flushed. If they do not match, the updated content of the soft buffer is kept and a further retransmission of the data packet is initiated.

In a more general scheme of incremental redundancy type HARQ, the transmitting side does not necessarily (as in Chase combining) retransmit an exact copy of the channel-encoded data packet, which was sent previously, but a channel-encoded data packet which differs in a number of bits from the previously sent channel-encoded data packet. E.g. if the channel-encoding process results in a code word for the payload bits including CRC bits, where the first n bits are equal to the payload bits including CRC bits (so-called systematic bits), and the remaining m bits are parity bits, the first transmission of the channel-encoded data packet would be done by puncturing (i.e. omitting) m′<=m bits from the parity bits, while the first retransmission would be done with other m′<=m bits punctured from the set of m parity bits (self-decodable incremental redundancy). It is also possible to send, in the first retransmission, only the punctured m′ bits, which is then known as non-self-decodable incremental redundancy.

For reconstructing the data, the punctured m′ bits are incorporated at their original position within the bit sequence of the initial transmission, and the channel decoding process is then applied to the soft bit vector containing the soft bits of the initial transmission and the missing m′ bits of the first retransmission. Assuming that before channel decoding of the initial transmission, the missing m′ bits are represented by soft-bits of value zero, the combining process of the decoding result of the initial transmission and the first retransmission may again be interpreted as soft-bit wise addition of the two soft-bit vectors (of length n+m), one in which the missing m′ bits are represented by zero (i.e. the bit sequence of the initial transmission), and one, where the missing n+m-m′ bits are represented by zero values (i.e. the bit sequence of the first retransmission).

In a second implementation different from the above description, it may also be possible, in the receiver, to produce a soft-bit vector as a result of the channel decoding process (i.e., e.g. after convolutional decoding or Turbo decoding), which soft bit vector is then used in the combining process, whereas in the previous description, the soft bits were the quantized values of the sampled pulse amplitudes before channel decoding. In this second implementation, the soft-bits of the combined soft bit vector are transformed into “0” and “1” based on a threshold decision, and this sequence of bits is then an estimate for the payload bits and CRC bits. Again, the estimated payload bits are used to compute CRC bits, and if the computed CRC bits match the estimates of the CRC bits, the data packet is considered as being reconstructed error free and the buffer for the soft bits may be flushed. If they do not match, the updated content of the soft buffer is kept and a further retransmission of the data packet is initiated.

In this document, the term “decoding” refers to either
according to the first implementation—generating the quantized values of the received pulse amplitudes, so that the decoding result is a soft bit vector of the quantized amplitude values, and the decoding result is obtained before channel decoding; or
according to the second implementation—generating soft bits as a result of the channel decoding process (e.g. done by convolutional decoding or Turbo decoding), so that the decoding result is obtained after channel decoding and may also result in a vector of soft bits.

Combining is always applied to soft bits, whether they resulted from a decoding process, which is just the quantization of sampled detected amplitude values (and before the usual channel decoding), or which is real channel decoding, which may yield soft bits.

In addition, in this document, the term “reconstructing the data” from the decoding result means either
according to the first implementation—applying channel decoding (e.g. by means of a convolutional decoder or a Turbo decoder) to the (possibly combined) soft bits (possibly after an additional transformation of the soft bit values into “0” and “1” bits by means of a threshold decision, so that “0” and “1” are the input values of the channel decoder rather than quantized values); the result of the channel decoding then is a vector of estimates for the payload bits and the CRC bits, and from the estimates of the payload bits the CRC bits are computed (by means of the known CRC polynomial), and are compared with the estimates of the CRC bits; or
according to the second implementation—transforming based on a threshold decision the (possibly combined) soft bits into “0” and “1” bits, which are estimates for the payload bits and the CRC bits, and additionally computing from the estimates of the payload bits (by means of the known CRC polynomial) the CRC bits, and comparing the computed CRC bits with the estimates of the CRC bits.

Reconstructing of the data leads to an error-free reconstruction result, if the computed CRC bits match the estimates of the CRC bits. If they do not match, the reconstruction result is erroneous.

In this terminology, a decoding result contains a number of uncorrectable errors, if the reconstruction of the data from the decoding result leads to an erroneous reconstruction result.

A combined decoding result results from combining at least two decoding results, or from combining decoding results and combined decoding results.

The expression “retransmission for a (data) packet” is used here in order to state that the retransmitted bits do not necessarily form an exact copy of the bits, which were sent in the initial transmission of the packet.

In a contrast to this, “retransmission of data” is used here to denote both “a retransmission of a (data) packet” (i.e. an exact copy of the data packet is retransmitted) and “a retransmission for a (data) packet (i.e. an exact copy of the data packet is retransmitted or the bits carried in the retransmission differ from the bits of the initial transmission).

However, in the above described data decoding schemes, the combining process combines successive data packet receptions, until the code rate is low enough to provide complete error correction. Reconstruction of the data is always applied to the sum of the soft bit vector of the last retransmission and the soft bit vector kept in the soft buffer, which is the sum of the soft bit vectors of all previous receptions.

It is an object of the present invention to provide for an efficient decoding of data.

According to an exemplary embodiment of the present invention as set forth in claim 1, the above object may be solved by receiving an initial transmission and at least one retransmission of data from a transmitting station in a receiving station, wherein a decoding of the initial transmission of the data results in a first decoding result and a decoding of the at least one retransmission of the data results in at least one second decoding result, and by combining selected ones of the first and at least one second decoding results into a combined decoding result for reconstructing the data resulting in a combined reconstruction result.

In other words, according to this exemplary embodiment of the present invention, a method for decoding of data is provided, wherein the data is reconstructed by soft-combining selected data packet receptions after they have been decoded.

Advantageously, by combining selected ones of the first and at least one second decoding results for reconstructing the data, not the full history of the channel conditions since the initial transmission is contained in the combined decoding result. Therefore, if the quality of the initial transmission and, accordingly, the quality of the first decoding result is very bad and the quality of the following retransmissions of the data is good enough, a combination of the respective second decoding results may lead to a better or even to an error free reconstruction result.

According to another exemplary embodiment of the present invention as set forth in claim 2, the data is transmitted as a data packet and all sub-combinations of the first and at least one second decoding results are used for reconstructing the data, wherein each sub-combination of the first and at least one second decoding results leads to a respective combined reconstruction result.

In other words, after receiving the N-th retransmission of the data packet all partial sums or sub-combinations of the decoded first and second decoding results are considered in order to obtain an error free version of the transmitted data packet.

According to another exemplary embodiment of the present invention as set forth in claim 3, the data is transmitted as a data packet and at least one sub-combination of the first and at least one second decoding results is used for reconstructing the data, wherein each of the used sub-combinations leads to a respective combined reconstruction result.

In other words, not all possible partial sums or sub-combinations of the first and at least one second decoding results have to be built, but only a group of sub-combinations, or even only one sub-combination of selected ones of the first and at least one second decoding results. In this context it should be noted that the first decoding result refers to the initial transmission of the data packet and the at least one second decoding result refers to the at least one retransmission of the data packet. Therefore, a sub-combination of selected ones of the first and at least one second decoding results may be understood as a partial sum of selected ones of the initial transmission and the at least one retransmission of the data packet.

According to another exemplary embodiment of the present invention as set forth in claim 4, a limited number of the first and at least one second decoding results is combined into a combined decoding result for reconstructing the data resulting in a combined reconstruction result.

Advantageously, by using a limited number of the first and at least one second decoding results for combination in order to reconstruct the data, the required processing power and memory are effectively reduced while still providing a considerably higher chance of a successful or error free combined reconstruction result, than with the state-of-the-art approach.

According to another exemplary embodiment of the present invention as set forth in claim 5, an estimation is performed which one of the decoding results and at least one combined decoding result is the best, i.e. contains the lowest number of uncorrectable errors. After the estimation, soft buffers, which contain decoding results, for which a higher number of uncorrectable errors is estimated, are being flushed. By doing so, valuable memory resources are set free and may be used for further saving of data.

According to another exemplary embodiment of the present invention as set forth in claim 6, after each retransmission of the data packet, it is checked, whether there are uncorrectable errors in the decoding result referring to this particular latest retransmission of the data packet and, in case there is no uncorrectable error found in that particular decoding result and in at least one combined decoding result, the particular decoding result or the respective combined decoding result in which there is no uncorrectable error found is considered to present an error free version of the data packet and no further combination of decoding results, and retransmissions of the data packet are performed. On the other hand, in case there is a number of uncorrectable errors found in the particular decoding result referring to the latest retransmission of the data packet and in case there is a number of uncorrectable errors found in each of the at least one combined decoding results as well, the particular latest decoding result and the at least one combined decoding result are considered to represent erroneous versions of the data packet. Therefore, one or more further combinations or sub-combinations of decoding results, check for uncorrectable errors and retransmissions of the data packet are performed.

Advantageously, the method according to this exemplary embodiment of the present invention stops the process of data packet retransmission and combination of decoding results whenever a data packet is retransmitted error free or whenever a sub-combination of first and second decoding results is found to be error free and, therefore, considered to represent an error free version of the data packet.

According to another exemplary embodiment of the present invention as set forth in claim 7, the first and at least one second decoding results of the initial transmission and the at least one retransmission of the data packet are represented in the form of respective soft bit vectors. A combination of selected ones of these decoding results is performed by summing up the respective soft bit vectors of these decoding results. This leads to a new soft bit vector, which represents the combination of the selected decoding results.

According to another exemplary embodiment of the present invention as set forth in claim 8, the estimation of which one of the considered decoding results and/or combined decoding results contains the lowest number of uncorrectable errors is performed by means of comparing the sum metrics of the ultimate survivor paths in the Trellis diagram, which are obtained for each one of the considered decoding results and/or combined decoding results. Advantageously, these sum metrics of the survivor paths have to be computed anyway for reconstructing the data, if convolutional codes are used, so that no significant increase in implementation complexity results from this estimation.

According to another exemplary embodiment of the present invention as set forth in claim 9, the method is an extension of one of the chase combining type HARQ and the incremental redundancy type HARQ.

According to another exemplary embodiment of the present invention as set forth in claim 10, a communication system is provided for performing a decoding of data, comprising a transmitting station and a receiving station. The transmitting station is adapted to perform an initial transmission and at least one retransmission of data from the transmitting station to the receiving station. The receiving station is adapted to receive the initial transmission and the at least one retransmission of the data from the transmitting station. Furthermore, the receiving station is adapted to decode the initial transmission of the data, which results in a first decoding result, and to decode the at least one retransmission of the data, which results in at least one second decoding result. Furthermore, the receiving station is adapted to combine selected ones of the first and at least one second decoding results into a combined decoding result in order to reconstruct the data, which leads to a combined reconstruction result.

According to another exemplary embodiment of the present invention as set forth in claim 11, a receiving station for a communication system for performing a decoding of data is provided, wherein the receiving station is adapted to receive an initial transmission and at least one retransmission of data from the transmitting station. Furthermore, the receiving station is adapted to decode the initial transmission of the data, which leads to a first decoding result, and to decode the at least one retransmission of the data, which leads to at least one second decoding result. Furthermore, the receiving station is adapted to combine selected ones of the first and at least one second decoding results into a combined decoding result in order to reconstruct the data, which leads to a combined reconstruction result.

It may be seen as the gist of an exemplary embodiment of the present invention that selected ones of the first and at least one second decoding results of transmitted and retransmitted data are combined in order to reconstruct the data. Due to this, the number of retransmissions of the data necessary for decoding the data error free may be reduced. Hence, according to an aspect of the present invention, not all of the transmission and the retransmissions are used for reconstructing the final decoding result, but only those selected ones which yield the best final decoding result, i.e. those containing the least number of errors.

These and other aspects of the present invention will become apparent from and elucidated with reference to the embodiments described hereinafter.

Exemplary embodiments of the present invention will be described in the following, with reference to the following drawings:

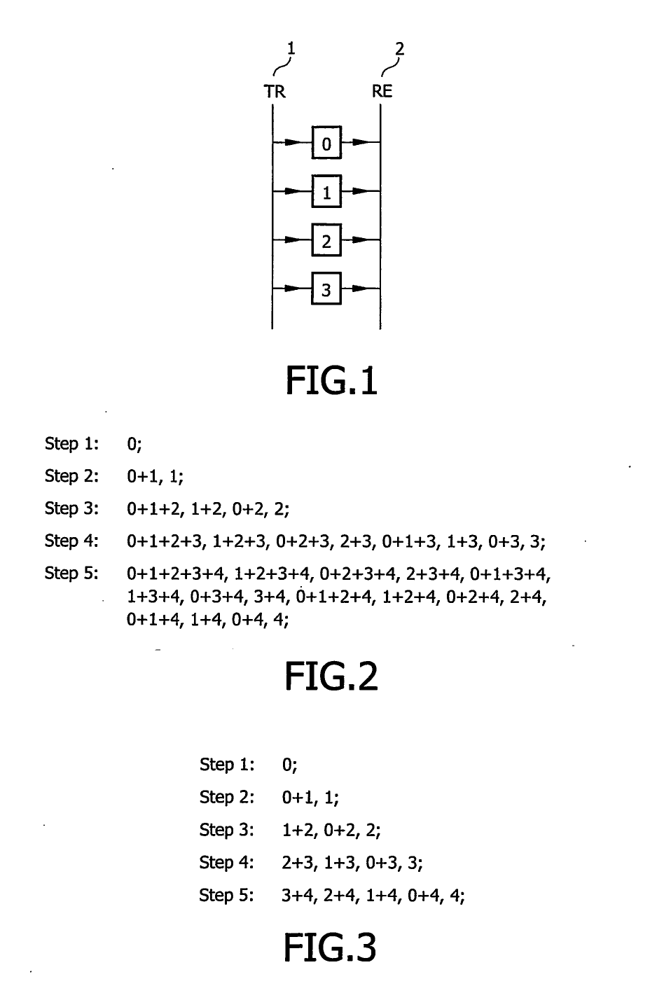

FIG. 1 shows a simplified timing chart, depicting an initial transmission and a plurality of retransmissions of a data packet from a transmitting station to a receiving station according to an exemplary embodiment of the present invention.

FIG. 2 shows a set of sub-combinations of an exemplary embodiment of a method according to the present invention.

FIG. 3 shows another set of sub-combinations of another exemplary embodiment of a method according to the present invention.

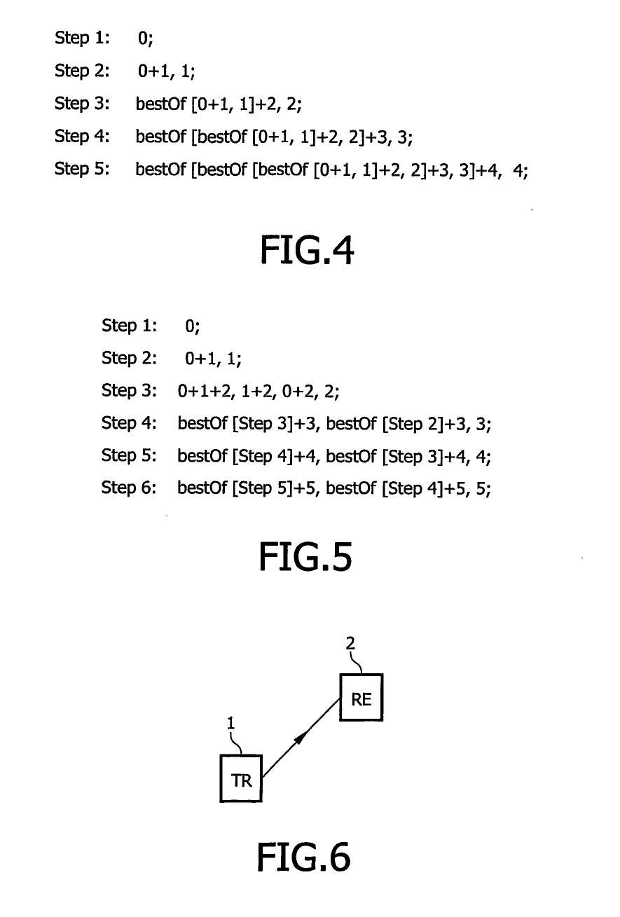

FIG. 4 shows another set of sub-combinations of another exemplary embodiment of a method according to the present invention.

FIG. 5 shows another set of sub-combinations of another exemplary embodiment of a method according to the present invention.

FIG. 6 shows a schematic representation of the communication system for performing a decoding of data according to an exemplary embodiment of the present invention.

FIG. 1 shows a simplified timing chart of an exemplary embodiment of a method for decoding of data according to the present invention. “0” refers to an initial transmission of a data packet from a transmitting station 1 to a receiving station 2. “1” refers to a first retransmission of the data packet from the transmitting station 1 to the receiving station 2. Accordingly, “2” and “3” refer to a second and third retransmission of the data packet from the transmitting station 1 to the receiving station 2, respectively. After receiving the initial transmission “0” of the data packet, the initial transmission “0” is decoded in the receiving station 2 resulting in a first decoding result. After receiving the first retransmission “1” of the data packet, the receiving station decodes the first retransmission “1”, resulting in a second decoding result. Accordingly, the receiving station 2 decodes the second retransmission of the data packet “2” after “2” has been received in the receiving station 2 resulting in another second decoding result. After receiving the third retransmission of the data packet “3”, the receiving station 2 decodes the retransmitted data packet “3” resulting in another second decoding result. It should be noted that all decoding results “0”, “1”, “2” and “3” may be different. This difference may arise from the fact that different payload bits have been transmitted or retransmitted according to a retransmission protocol using self-decodable incremental redundancy. Another reason for the difference of the data packets “0”, “1”, “2” and “3” may be a variation of channel conditions during retransmission of the data packets resulting in different losses and changes in each retransmission of the data packet. In a chase combining type HARQ the combing process combines successive data packet receptions, until the code rate is low enough to provide complete error correction or reconstruction of a data packet.

However, in the known chase combining type HARQ reconstruction of the data (as described above) is performed based on the combined decoding result of all receptions up to the last one.

This means the full history of the channel conditions, since the initial transmission, are contained in the combining result or combined decoding result. However, it is easily possible that for example the third retransmission “3” is a successful retransmission due to very good channel conditions and, therefore, may be reconstructed error free. In case of the known chase combining type HARQ this would pass unnoticed, since the decoding results of all successive packet receptions are combined before performing a reconstruction of the data including the cyclic redundancy check. The cyclic redundancy check then determines whether there are uncorrectable errors in a combined decoding result. If no uncorrectable error is found in a combined decoding result, the combined decoding result is considered to represent an error free version of the data packet and no further combination of decoding results, and retransmission of the data packet are performed. On the other hand, if uncorrectable errors are found in the combined decoding result, the combined decoding result is considered to represent an erroneous version of the data packet and one or more further combination of decoding results or retransmission of the data packet are performed.

Since the previous initial transmission “0” and the first and the second retransmission “1”, “2”, respectively, contain many errors due to very bad channel conditions, while the third retransmission of the data packet “3” contains virtually no errors at all, combining the second decoding result of the third retransmission “3” with the other second decoding results of the first retransmission and the second retransmission “1”, “2”, respectively, and the first decoding result of the initial transmission “0” may lead to a first combined decoding result or decoding result with errors and may, therefore, require additional, unnecessary retransmissions.

Likewise, it is possible that, for example, the quality of the initial transmission “0” is very bad and the quality of the first and second retransmissions “1”, “2”, respectively, are such that a combination of the second decoding result of the first retransmission “1” with the second decoding result of the second retransmission “2” leads to a successful combined decoding result. In the above context, the term successful combined decoding result refers to a combined decoding result of a data packet whose reconstruction was error free, meaning that a cyclic redundancy check does not indicate any error.

In general, it can be stated that, after receiving the N-th retransmission of a data packet, there may be a sub-combination created out of the first decoding result and the N second decoding results of the data packet resulting in a combined decoding result of the data packet which passes the cyclic redundancy check, wherein this sub-combination consists of a number K of selected ones of the first and at least one second decoding results with K<=N+1. However, it is not in all cases true, that a partial sum or combined decoding result, which shows the least number of uncorrectable errors will provide the best result in terms of uncorrectable errors when combined with a second decoding result of a further retransmission of the data packet. This depends on the error structure in this further retransmission and the error structure in the considered partial sum or combined decoding result.

It may therefore be important to build sub-combinations of selected ones of the first and at least one second decoding results after a retransmission of the data packet in order to increase the chance of finding an error free version of the data packet and to reduce the number of retransmissions necessary for error free decoding of the data packet, thereby improving the throughput of the transmission.

FIG. 2 shows a set of sub-combinations of the first and at least one second decoding results for reconstructing the data packet.

In FIGS. 2 to 5 “0” refers to a decoding result of an initial transmission of a data packet, which is called a first decoding result. “1”, “2”, “3”, “4” and “5” refer to second decoding results of a first, second, third, fourth and fifth retransmission of the data packet, respectively.

It should be noted that, according to the exemplary embodiments of the present invention depicted in FIGS. 2 to 5, the first and at least one second decoding results- are presented in the form of respective soft bit vectors and that a combination of the selected ones of the first and at least second decoding results is performed by summing up the respective soft bit vectors of the first and the at least one second decoding results resulting in a new soft bit vector representing the combination (or combined decoding result) of the selected ones of the first and the at least one second decoding results.

In a first step, an initial transmission of the data packet is performed and decoded resulting in a first decoding result “0”. A reconstruction of the data with cyclic redundancy check is performed on the first decoding result “0” and it is assumed that the reconstruction result is not error-free. Hence, a first retransmission of the data packet is performed and decoded, resulting in a second decoding result “1”.

According to an aspect of this exemplary embodiment of the present invention, a determination of whether there are uncorrectable errors in the second decoding result 1 is performed. If there is no uncorrectable error found in the second decoding result 1, the second decoding result 1 is considered to represent an error free version of the data packet and no further combination of decoding results, determination of whether there are uncorrectable errors and retransmission of the data packet are performed. However, if there are uncorrectable errors found in the second decoding result 1, a combination of the first decoding result 0 and the second decoding result 1 is performed, resulting in a combined decoding result 0+1 (step 2). After that a determination of whether there are uncorrectable errors in the combined decoding result 0+1 is performed and a second retransmission of the data packet is initiated, if the number of uncorrectable errors in the combined decoding result 0+1 is unequal to zero. Again, if there is no uncorrectable error found in the combined decoding result 0+1, the combined decoding result is considered to represent an error free version of the data packet and no further combinations, attempts for reconstructing the data and retransmissions of the data packet are performed.

In case no error free version of the data packet has been generated, a second retransmission of the data packet from the transmitting station to the receiving station is performed and the second retransmission of the data packet is decoded, resulting in another second decoding result 2. If a performed error determination does not indicate that the second decoding result 2 represents an error free version of the data packet, further combinations and sub-combinations of the first and second decoding results are performed, namely 0+1+2, 1+2 and 0+2 (step 3). Again, it is determined whether there are uncorrectable errors in the combined decoding results 0+1+2, 1+2, 0+2, and if one of the three combined decoding results does not contain any uncorrectable error, this particular combined decoding result is considered to represent an error free version of the data packet and no further retransmissions steps are performed.

On the other hand, if all the three combined decoding results contain a number of uncorrectable errors, a third retransmission of the data packet is performed.

This third retransmission of the data packet is then decoded in the receiving station, resulting in another second decoding result 3. After determining whether there are uncorrectable errors in the second decoding result 3 and finding that the number of uncorrectable errors in the second decoding result 3 is unequal to zero, further combinations of the first and second decoding results are performed, namely 0+1+2+3, 1+2+3, 0+2+3, 2+3, 0+1+3, 1+3 and 0+3 (step 4). If a following error determination finds that each of the seven combined decoding results contains a number of uncorrectable errors which is not zero, a fourth retransmission of the data packet is performed, followed by a decoding of the fourth retransmission, resulting in another second decoding result 4.

After receiving the fourth retransmission of the data packet in the receiving station and decoding the fourth retransmission of the data packet, resulting in a second decoding result 4, it is determined if there are uncorrectable errors in the second decoding result 4. If the second decoding result 4 has been decoded error free, the second decoding result 4 is considered to represent an error free version of the data packet and no further retransmission and combination steps are performed. However, if the second decoding result 4 contains a number of uncorrectable errors, further combinations and sub-combinations of selected ones of the first and second decoding results are performed, resulting in combined decoding results, namely 0+1+2+3+4, 1+2+3+4, 0+2+3+4, 2+3+4, 0+1+3+4, 1+3+4, 0+3+4, 3+4, 0+1+2+4, 1+2+4, 0+2+4, 2+4, 0+1+4, 1+4 and 0+4 (step 5). According to this exemplary embodiment of the present invention, further retransmissions of the data packet and combinations and sub-combinations of selected ones of the first and second decoding results for reconstructing the data packet are performed until a cyclic redundancy check indicates that an error free version of the combined decoding result or of a second decoding result has been found.

In each of the five steps of the above-described scheme all the newly combined decoding results have to be checked for their number of uncorrectable errors. Advantageously, this error determination is performed for the shortest partial sums or combined decoding results first.

As an aspect of this exemplary embodiment, in this scheme when receiving the N-th retransmission, all those partial sums or sub-combinations of soft-bit vectors are considered for the determination of uncorrectable errors, which have not yet been considered when previous retransmissions were received and analyzed.

If K denotes the number of retransmissions and T(K) is the number of different partial sums to be analyzed for the K-th retransmission, T(K)=T(K−1)+T(K−2)+. . . +T(0)=2^{K}. Thus, the requirements for memory grow exponentially with the number of retransmissions. The requirements for processor capacity for combining or sub-combining first and second decoding results may even grow faster. For a small number of retransmissions this may be acceptable.

Assuming such a scheme, it may be disadvantageous (if delay aspects are not relevant, due to which reception of a packet might become obsolete) to abort the on-going transmission/retransmission of a data packet A (not shown in the figure) and then start the transmission of another data packet B (not shown in the figure) because this following data packet B would face the same problems as the previous data packet A in providing an error-free reconstruction result. Only if it were right to assume that data packet A should no longer be sent, since the data carried has become obsolete, abortion should be applied.

FIG. 3 shows a set of sub-combinations of the first and at least one second decoding results according to another exemplary embodiment of a method according to the present invention. It should be noted that, according to this exemplary embodiment of the present invention, the first and at least one second decoding results are presented in the form of respective soft bit vectors and that a combination of the selected ones of the first and at least second decoding results is performed by summing up the respective soft bit vectors of the first and the at least one second decoding results resulting in a new soft bit vector representing the combination of the selected ones of the first and the at least one second decoding results.

According to the method depicted in FIG. 3, in order to reduce the number reconstruction attempts with cyclic redundancy checks as well as the required memory one could combine partial sums with only one or two first and second decoding results used for reconstructing the data. In an initial transmission the data packet is transmitted for the first time and then decoded in the receiving station resulting in a first decoding result 0 (step 1). After that a reconstruction of the data with cyclic redundancy check is performed, in order to determine, whether there are uncorrectable errors in the first decoding result 0. If the data is not reconstructed error free, a first retransmission of the data is performed and a second decoding result 1 is generated. In case the second decoding result 1 contains a number of uncorrectable errors, the first and the second decoding results are combined, resulting in a combined decoding result 0+1 (step 2). The following steps 3 to 5 are performed according to the method described in FIG. 2, except that not all sub-combinations of the first and at least one second decoding results are used for reconstructing the data but only a limited number of the first and at least one second decoding results, namely, sub-combinations comprising only one or two first or second decoding results. After each retransmission of the data packet and the following decoding of the retransmitted data packet which results in a respective second decoding result, the respective second decoding result is checked for uncorrectable errors. In case no uncorrectable errors are found in the respective second decoding result, no further steps are taken and the respective second decoding result is considered to represent an error free version of the data packet. On the other hand, if the respective second decoding result contains a number of uncorrectable errors, further sub-combinations of the first and at least one second decoding results are generated and the resulting combined decoding results are checked for uncorrectable errors. If no error is found in a combined decoding result, this combined decoding result is considered to represent a valid version of the data packet and no further steps are performed.

The exemplary embodiment of the method according to the present invention as depicted in FIG. 4 may lead to a further reduction of the processing power requirements and memory requirements of the system used for performing the data decoding scheme. The decoding scheme depicted in FIG. 4 combines in each step the latest retransmission of the data packet with the “best” partial sum or the “best” combined decoding result of the previous steps. The “best” partial sum may be either the sum of the soft bit vectors of the initial transmission and all previous retransmissions of the data packet or one sum which is estimated to have the lowest number of uncorrectable errors. In case of convolutional codes used for channel coding, such an estimation could be based on the sum metric of the ultimate survivor path in the Trellis diagram, which sum metric of the ultimate survivor path is determined for each considered decoding result or combined decoding result. The decoding result or combined decoding result with the highest sum metric of the ultimate survivor path is considered as containing the least number of uncorrectable errors, or in other words, the best estimate of the received code word. The use of the “ultimate survivor path” and the “path metric” in the above described manner is described e.g. in J. S. Lee and L. E. Miller, “CDMA Systems Engineering Handbook”, Artech House Publishers 1998, and of J. G. Proakis, “Digital Communications”, McGraw-Hill International Editions, 1995 which are both hereby incorporated by reference. It should be noted that if the estimation is done as described above, in the above mentioned first implementation, this estimation would be done as part of the process of reconstructing the data (which in this implementation includes channel decoding), while in the second implementation, the estimation would be done already as part of the decoding process (which in this implementation includes channel decoding).

Again, the decoding scheme depicted in FIG. 4 is performed according to the decoding schemes depicted in FIGS. 2 and 3, meaning that in each step, after a retransmission of the data packet is performed, it is determined whether there are uncorrectable errors in the decoding result of that latest retransmission and, if necessary, a combination of the best previous first or second decoding result or combined decoding result with the latest second decoding result is performed, for which combination a reconstruction of the data is then attempted.

Advantageously, only two memory units are needed in the soft-buffer for performing the above-described decoding and data reconstruction scheme, since only the “best” partial sum is saved and the decoding results or combined decoding results other than the “best” partial sum do not need to be kept stored.

In FIG. 4, bestOf [A, B] refers to the operation selecting among the soft bit vectors A and B the one soft bit vector which is estimated to have the least number of uncorrectable errors. If A and B are estimated to have the same number of uncorrectable errors, a random choice may be performed which one of A and B will be saved and which other one of A and B will be erased or flushed.

FIG. 5 depicts another set of sub-combinations according to another exemplary embodiment of a method according to the present invention. An advantage of the method shown in FIG. 5 is that it requires even less memory resources as, for example, the method depicted in FIG. 2, but still provides a very effective method for reconstructing the data, in fact much more effective than a conventional chase combining technique or incremental redundancy technique. Since the steps performed in the method of FIG. 5 are basically the same steps as in FIGS. 2 to 4, except for the fact that a different set of sub-combinations of the first and at least one second decoding results is used for reconstructing the data, only step 5 is described herein in more detail. It should be noted that step 5 is exemplary for step 4 and step 6, and that steps 1, 2 and 3 are described in FIG. 2. In step 5 a further retransmission of the data packet is performed and the retransmission of the data packet is decoded resulting in a second decoding result 4. Then an error determination is performed and if the number of uncorrectable errors in the second decoding result 4 is unequal to zero, two further sub-combinations are performed. The first sub-combination is the partial sum of the second decoding result 4 and the “best” partial sum of step 4. The second sub-combination is the partial sum of the second decoding result 4 and the “best” partial sum of step 3.

It should be noted that all of the above described decoding schemes are applicable for any type of self-decodable redundancy, e.g. chase combining type HARQ. Also, the above schemes described with reference to FIGS. 2-5 may also be combined with each other.

In principle, non-self-decodable redundancy can also be used, if some but 15 not all of the retransmissions only contain non-self-decodable redundancy. Then, in the schemes of FIGS. 2-5 only those decoding results or combined decoding results are considered, which consist of self-decodable redundancy: E.g. if decoding result 2 in FIG. 2 is non-self-decodable, but the others are self-decodable, decoding result 2 is only considered as part of a combined decoding result, which is then self-decodable, but not alone.

The non-self-decodable redundancy can thus be used in any sub-combination containing at least one self-decodable version of the data in order to produce a decoding result, which may have a lower estimate of the contained uncorrectable errors, until the reconstruction result is error-free.

FIG. 6 shows a schematic representation of the communication system for performing a decoding of data according to an exemplary embodiment of the present invention, the system comprising a transmitting station 1 and a receiving station 2. The transmitting station is adapted to perform an initial transmission and at least one retransmission of the data from the transmitting station to the receiving station and the receiving station is adapted to receive the initial transmission and the at least one retransmission of the data from the transmitting station. Furthermore, the receiving station is adapted to decode the initial transmission of the data resulting in a first decoding result and to decode the at least one retransmission of the data resulting in at least one second decoding result. Furthermore, the receiving station is adapted to combine selected ones of the first and at least one second decoding results into a combined decoding result for reconstructing the data resulting in a combined reconstruction result.

This communication system and this receiving station, according to an aspect of the present invention, are adapted to perform the method of the present invention. In particular, the communication system and the receiving station may be adapted to perform one or more of the methods described with reference to FIGS. 2-5.

1. Method for decoding of data, the method comprising the steps of: receiving an initial transmission and at least one retransmission of data from a transmitting station in a receiving station; wherein a decoding of the initial transmission of the data results in a first decoding result and a decoding of the at least one retransmission of the data results in at least one second decoding result; combining selected ones of the first and at least one second decoding results into a combined decoding result for reconstructing the data.

2. The method of claim 1, wherein the data is transmitted as a data packet; wherein all sub-combinations of the first and at least one second decoding results are used for reconstructing the data; wherein each sub-combination of the first and at least one second decoding results results in a respective combined decoding result.

3. The method of claim 1, wherein the data is transmitted as a data packet; wherein at least one sub-combination of the first and at least one second decoding results is used for reconstructing the data; wherein each at least one sub-combination of the first and at least one second decoding results results in a respective combined decoding result.

4. The method of claim 3, wherein a limited number of the first and at least one second decoding results is combined into a combined decoding result for reconstructing the data.

5. The method of claim 3, wherein an estimation is performed which one of the first decoding result, the at least one second decoding result, and the at least one combined decoding result contains the lowest number of uncorrectable errors; discarding decoding results or combined decoding results, for which a higher number of uncorrectable errors is estimated.

6. The method of claim 3, wherein among the at least one second decoding result there is a third decoding result, wherein the third decoding result is the decoding result of the latest retransmission of the data packet; wherein, if there is no uncorrectable error found in the third decoding result or in a combined decoding result, the third decoding result or the combined decoding result in which there is no uncorrectable error found is considered to represent an error free version of the data packet and no further combination of decoding results, and retransmission of the data packet are performed; and wherein, if there is a number of uncorrectable errors found in the third decoding result and in each of the at least one combined decoding results, the third decoding result and the at least one combined decoding result are considered to represent erroneous versions of the data packet and one or more further combinations of decoding results or retransmissions of the data packet are performed.

7. The method of claim 3, wherein the first and at least one second decoding results are represented in form of respective soft bit vectors; and wherein a combination of selected ones of the first and the at least one second decoding results is performed by summing up the respective soft bit vectors of the first and the at least one second decoding results resulting in a new soft bit vector representing the combination of the selected ones of the first and the at least one second decoding results.

8. The method of claim 3, wherein the estimation of which one of at least one of the considered decoding results and the combined decoding results contains the lowest number of uncorrectable errors is performed by means of comparing sum metrics of ultimate survivor paths, which are obtained for each one of the at least one of the considered decoding results and the combined decoding results.

9. The method of claim 3, wherein the method is an extension of one of the Chase Combining type HARQ and the Incremental Redundancy type HARQ.

10. Communication system for performing a decoding of data, comprising a transmitting station and a receiving station, wherein the transmitting station is adapted to perform an initial transmission and at least one retransmission of the data from the transmitting station to the receiving station; wherein the receiving station is adapted to receive the initial transmission and the at least one retransmission of data from the transmitting station; wherein the receiving station is adapted to decode the initial transmission of the data resulting in a first decoding result and to decode the at least one retransmission of the data resulting in at least one second decoding result; wherein the receiving station is adapted to combine selected ones of the first and at least one second decoding results into a combined decoding result for reconstructing the data.

11. Receiving station for a communication system for performing a decoding of data, wherein the receiving station is adapted to receive an initial transmission and at least one retransmission of data from the transmitting station; wherein the receiving station is adapted to decode the initial transmission of the data resulting in a first decoding result and to decode the at least one retransmission of the data resulting in at least one second decoding result; wherein the receiving station is adapted to combine selected ones of the first and at least one second decoding results into a combined decoding result for reconstructing the data.
